(19) United States
(12) Patent Application Publication
(10) Pub. No.: US 2026/0299354 A1
(43) Pub. Date: Oct. 1, 2026

(54) DISPLAY APPARATUS AND ELECTRONIC SYSTEM

(71) Applicant: AUO Corporation, Hsinchu City (TW)

(72) Inventors: Chi Sheng Chang, Hsinchu City (TW); Pang-Hsuan Liu, Hsinchu City (TW)

(73) Assignee: AUO Corporation, Hsinchu City (TW)

(21) Appl. No.: 19/369,336

(22) Filed: Oct. 27, 2025

(30) Foreign Application Priority Data
Mar. 31, 2025 (TW) 114112269

(51) Int. Cl. G02F 1/13357; F21V 8/00

(52) U.S. Cl. CPC G02F 1/133605; G02B 6/0055; G02F 1/133606; G02F 1/133608

(57) ABSTRACT

A display apparatus includes a backlight module and a display panel disposed on the backlight module. The backlight module includes a reflector, at least one light-emitting element and at least one optical film. The reflector includes a first portion and a second portion outside the first portion. The first portion of the reflector has an opening. The at least one optical film is located above the reflector. A first direction is perpendicular to the at least one optical film. There is a first distance between the first portion of the reflector and the at least one optical film in the first direction. There is a second distance between the second portion of the reflector and the at least one optical film in the first direction. The first distance is less than the second distance. In addition, an electronic system including the display apparatus is also provided.

### CROSS-REFERENCE TO RELATED APPLICATION

This application claims the priority benefit of Taiwan application serial no. 114112269, filed on Mar. 31, 2025. The entirety of the above-mentioned patent application is hereby incorporated by reference herein and made a part of this specification.

### BACKGROUND

### Technical Field

The present disclosure relates to a display apparatus and an electronic system.

### Related Art

For current automotive under display camera models, in order to improve the optical transmittance of the image sensor, the optical film in the display module in front of the image sensor must be perforated. Since the viewing angle of the image sensor must be wide enough to provide good recognition effects, the opening of the optical film must also have a certain width. However, the larger the opening of the optical film, the more difficult it is to compensate for the visual quality impact of the optical film opening on the display module, and the opening of the optical film is more easily perceived by users.

### SUMMARY

The present disclosure provides a display apparatus with good performance.

The present disclosure provides an electronic system with good performance.

The display apparatus of the present disclosure includes a backlight module and a display panel disposed on the backlight module. The backlight module includes a reflector, at least one light emitting element, and at least one optical film. The reflector includes a first portion and a second portion outside the first portion. The first portion of the reflector has an opening. The at least one optical film is located above the reflector. A first direction is perpendicular to the at least one optical film. There is a first distance between the first portion of the reflector and the at least one optical film in the first direction. There is a second distance between the second portion of the reflector and the at least one optical film in the first direction. The first distance is less than the second distance.

The electronic system of the present disclosure includes a backlight module, a display panel, an image sensor, and a processing element. The backlight module includes a reflector, at least one light emitting element, and at least one optical film. The reflector includes a first portion and a second portion outside the first portion. The first portion of the reflector has an opening. The at least one light emitting element is located on the reflector. The at least one optical film is located above the reflector. A first direction is perpendicular to the at least one optical film. There is a first distance between the first portion of the reflector and the at least one optical film in the first direction. There is a second distance between the second portion of the reflector and the at least one optical film in the first direction. The first distance is less than the second distance. The display panel is disposed on the backlight module. The image sensor is disposed corresponding to the opening of the first portion of the reflector. The processing element is electrically connected to the image sensor.

### BRIEF DESCRIPTION OF THE DRAWINGS

FIG. 1 is a cross-sectional schematic diagram of an electronic system according to an embodiment of the present disclosure.

FIG. 2 is a top view schematic diagram of a reflector, light emitting element, and image sensor according to an embodiment of the present disclosure.

FIG. 3 is a cross-sectional schematic diagram of an electronic system according to another embodiment of the present disclosure.

FIG. 4 is a top view schematic diagram of a reflector, light emitting element, and image sensor according to another embodiment of the present disclosure.

FIG. 5 is a cross-sectional schematic diagram of an electronic system according to yet another embodiment of the present disclosure.

FIG. 6 is a top view schematic diagram of a reflector, light emitting element, and image sensor according to yet another embodiment of the present disclosure.

FIG. 7 is a cross-sectional schematic diagram of an electronic system according to still another embodiment of the present disclosure.

FIG. 8 is a cross-sectional schematic diagram of an electronic system according to an embodiment of the present disclosure.

FIG. 9 is a cross-sectional schematic diagram of an electronic system according to another embodiment of the present disclosure.

### DESCRIPTION OF THE EMBODIMENTS

Reference will now be made in detail to exemplary embodiments of the present disclosure, examples of which are illustrated in the accompanying drawings. Wherever possible, the same reference numerals are used in the drawings and the description to refer to the same or like parts.

It should be understood that when an element such as a layer, film, region or substrate is referred to as being “on” or “connected to” another element, it may be directly on or connected to the other element, or intervening elements may also be present. Conversely, when an element is referred to as being “directly on” or “directly connected to” another element, no intervening elements are present. As used herein, “connected” may refer to physical and/or electrical connections. Furthermore, “electrically connected” or “coupled” may mean that other elements exist between the two elements.

As used herein, “about,” “approximately,” or “substantially” includes the stated value and average values within an acceptable deviation range of the particular value as determined by one of ordinary skill in the art, taking into consideration the measurement in question and the particular amount of error associated with measurement of the particular quantity (i. e., the limitations of the measurement system). For example, “about” may mean within one or more standard deviations of the stated value, or within ±30%, ±20%, ±10%, ±5%. Furthermore, “about,” “approximately,” or “substantially” as used herein may select a more acceptable deviation range or standard deviation depending on optical properties, etching properties, or other properties, and may not apply one standard deviation to all properties.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

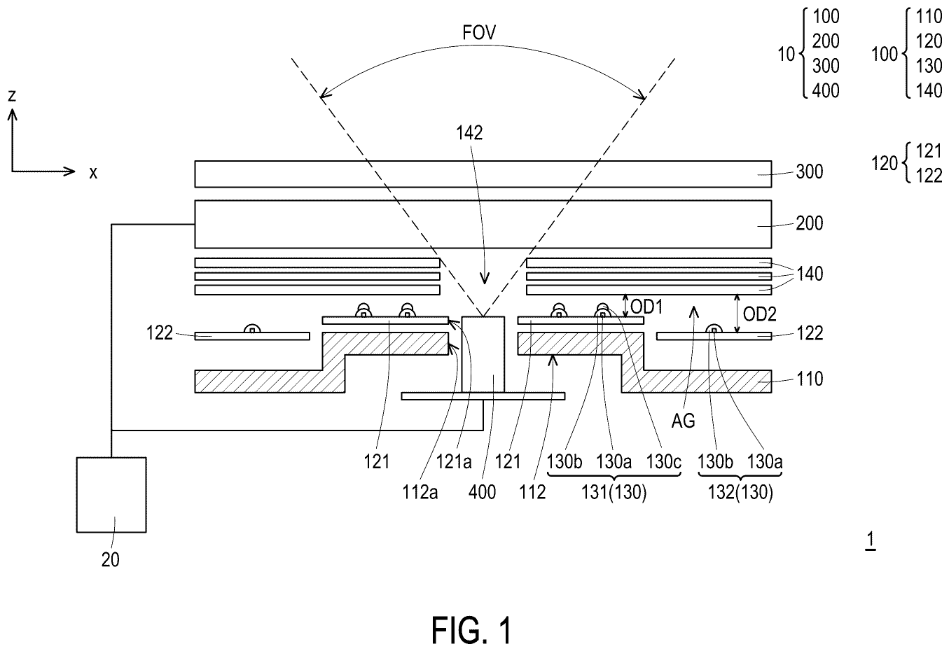

FIG. 1 is a cross-sectional schematic diagram of an electronic system according to an embodiment of the present disclosure. Referring to FIG. 1, the electronic system 1 includes a display apparatus 10. The display apparatus 10 includes a backlight module 100 and a display panel 200. The display panel 200 is disposed on the backlight module 100. The display panel 200 is a non-self-luminous display panel. For example, in some embodiments, the display panel 200 may be a liquid crystal display panel, but the present disclosure is not limited thereto. In some embodiments, the display apparatus 10 may further optionally include a protective cover plate 300 disposed on the display panel 200.

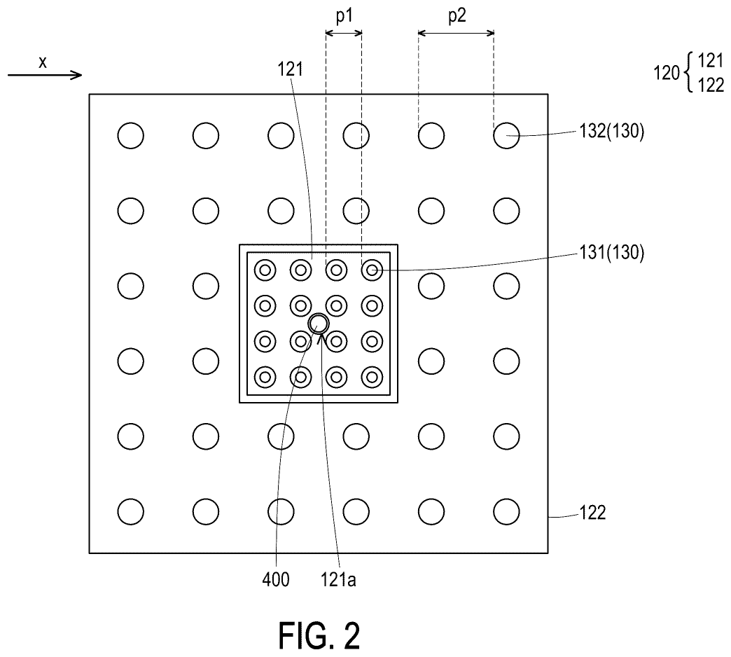

FIG. 2 is a top view schematic diagram of a reflector, light emitting elements, and image sensors according to an embodiment of the present disclosure. Referring to FIG. 1 and FIG. 2, the backlight module 100 includes a reflector 120, at least one light emitting element 130, and at least one optical film 140. The at least one light emitting element 130 is located on the reflector 120. The at least one optical film 140 is located above the reflector 120. In some embodiments, the light emitting element 130 may optionally be located between the at least one optical film 140 and the reflector 120, but the present disclosure is not limited thereto. For example, in some embodiments, the backlight module 100 may include three optical films 140, and the optical films 140 may include diffusion sheets, prism sheets, and the like. However, the present disclosure is not limited thereto, and the number and types of optical films 140 may be designed differently according to actual requirements.

The reflector 120 includes a first portion 121 and a second portion 122 outside the first portion 121. The first portion 121 of the reflector 120 has an opening 121a. The first portion 121 is a region of the reflector 120 immediately adjacent to the opening 121a. The second portion 122 is a region of the reflector 120 away from the opening 121a. In some embodiments, the optical film 140 may also have an opening 142, and the opening 142 of the optical film 140 and the opening 121a of the reflector 120 are used for allowing external light beams to pass through, so that the external light beams can be transmitted to the image sensor 400. In some embodiments, a ratio of an area of the first portion 121 of the reflector 120 to an area of the opening 121a may be greater than 120%, but the present disclosure is not limited thereto. In some embodiments, the image sensor 400 includes, for example, an infrared sensor, but the present disclosure is not limited thereto.

A first direction z is perpendicular to the optical film 140. There is a first distance OD1 between the first portion 121 of the reflector 120 and the optical film 140 in the first direction z, there is a second distance OD2 between the second portion 122 of the reflector 120 and the optical film 140 in the first direction z, and the first distance OD1 is less than the second distance OD2. In some embodiments, a ratio of the second distance OD2 to the first distance OD1 (OD2/OD1) may fall in a range of 1.5 to 5, but the present disclosure is not limited thereto.

In some embodiments, the display apparatus 10 further includes an image sensor 400, which is disposed corresponding to the opening 121a of the first portion 121 of the reflector 120. It is worth mentioning that the distance (i.e., the first distance OD1) between the reflector 120 and the optical film 140 in a region near the opening 121a corresponding to the image sensor 400 is smaller. Thereby, when the area of the opening 121a of the reflector 120 is smaller, a sufficiently wide viewing angle FOV may be provided for the image sensor 400. In addition, since the distance (i.e., the second distance OD2) between the reflector 120 and the optical film 140 in a region away from the opening 121a is larger, the visual quality of the display apparatus 10 can be good while providing a wide viewing angle FOV.

In some embodiments, each of the light emitting element 130 includes a light-emitting chip 130a and a transparent package 130b covering the light-emitting chip 130a. In some embodiments, the light emitting element 130 includes a plurality of first light-emitting elements 131 and a plurality of second light emitting elements 132, the plurality of first light-emitting elements 131 are disposed on the first portion 121 of the reflector 120, and the plurality of second light emitting elements 132 are disposed on the second portion 122 of the reflector 120. In some embodiments, each of the first light-emitting element 131 further includes a scatterer 130c disposed on the transparent package 130b, no scatterer 130c is disposed on the transparent package 130b of each of the second light emitting elements 132, and the transparent package 130b of each of the second light emitting elements 132 may directly contact the air gap AG between the optical film 140 and the reflector 120. Thereby, the visual quality of the display apparatus 10 may be further optimized. In some embodiments, a ratio of an area of the scatterer 130c of the first light-emitting element 131 to an area of the transparent package 130b of the first light-emitting element 131 may fall in a range of 20% to 60%, but the present disclosure is not limited thereto.

A second direction x is parallel to the optical film 140. In some embodiments, the plurality of first light-emitting elements 131 are arranged with a first spacing p1 in the second direction x, the plurality of second light emitting elements 132 are arranged with a second spacing p2 in the second direction x, and a ratio of the second spacing p2 to the first spacing p1 (p2/p1) may fall in a range of 0.99 to 3. In some embodiments, the ratio of the second spacing p2 to the first spacing p1 (p2/p1) may be greater than 1. That is, in some embodiments, the first spacing p1 may be less than the second spacing p2, but the present disclosure is not limited thereto.

In some embodiments, the backlight module 100 further includes a back frame 110. The reflector 120 and the optical film 140 are sequentially disposed on the back frame 110. It is worth noting that, in some embodiments, the back frame 110 has a recess 112, the recess 112 is recessed toward the display panel 200, the first portion 121 of the reflector 120 overlaps the recess 112 of the back frame 110, the recess 112 may have an opening 112a corresponding to the image sensor 400, and at least a portion of the image sensor 400 is disposed in the recess 112 of the back frame 110. Thereby, the display apparatus 10 may be thinned.

Referring to FIG. 1, the electronic system 1 includes a processing element 20 in addition to the aforementioned display apparatus 10. The processing element 20 is electrically connected to at least the image sensor 400. In some embodiments, the image sensor 400 is used to capture images in front of the display apparatus 10, and the processing element 20 (for example: a computer) may cause any component of the electronic system 1 to generate a corresponding response according to the images captured by the image sensor 400. For example, in some embodiments, the electronic system 1 is applied in a smart cabin, the image sensor 400 may be used to capture driver images, and if the processing element 20 determines that the driving condition is abnormal according to the driver images, the processing element 20 may cause a speaker (not shown) to emit a warning sound and/or cause the display panel 200 to display a warning screen, but the present disclosure is not limited thereto.

It must be explained here that the following embodiments use the component reference numbers and partial content of the aforementioned embodiments, wherein the same reference numbers are used to represent the same or similar components, and the description of the same technical content is omitted. For the description of the omitted parts, reference may be made to the aforementioned embodiments, and the following embodiments will not be repeated.

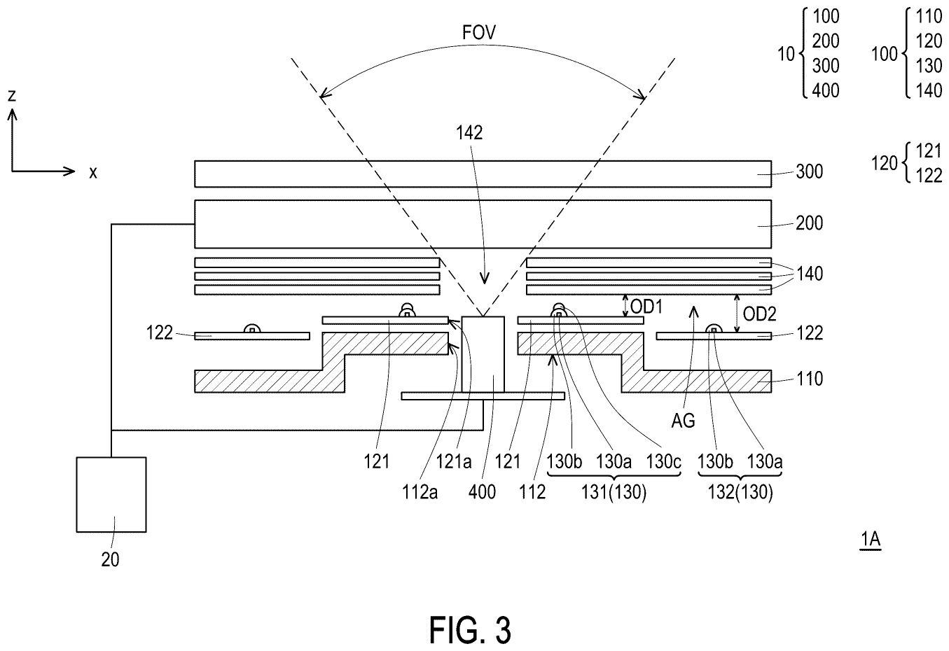

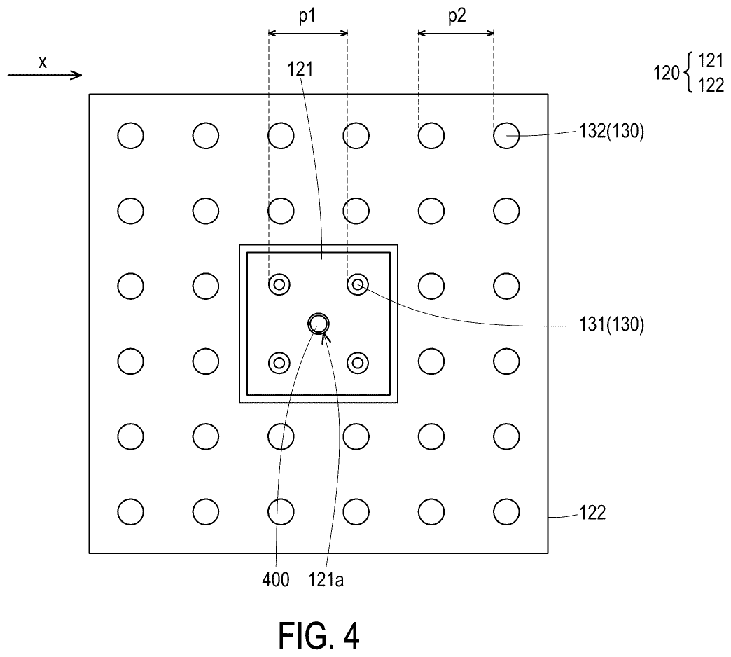

FIG. 3 is a cross-sectional view of an electronic system according to another embodiment of the present disclosure. FIG. 4 is a top view of a reflector, light emitting elements, and an image sensor according to another embodiment of the present disclosure. Referring to FIG. 3 and FIG. 4, the electronic system 1A of this embodiment is similar to the aforementioned electronic system 1, and the difference between both is that: in this embodiment, the ratio (p2/p1) of the second spacing p2 of the plurality of second light emitting elements 132 to the first spacing p1 of the plurality of first light-emitting elements 131 may be 1. In addition, in this embodiment, the ratio (OD1/p1) of the first distance OD1 to the first spacing p1 may be 0.4, and the ratio (OD2/p2) of the second distance OD2 to the second spacing p2 may be 0.2.

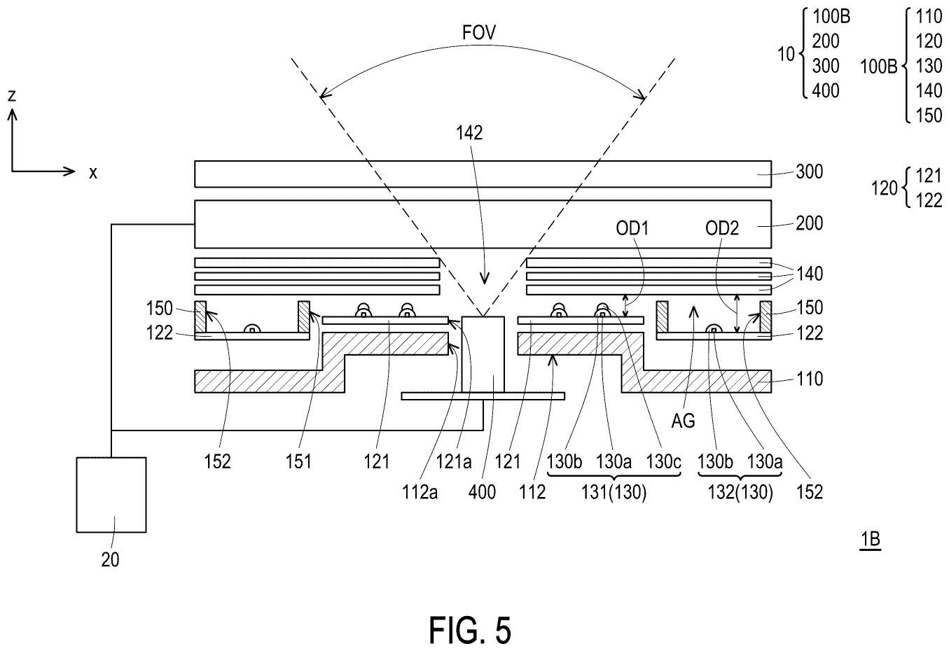

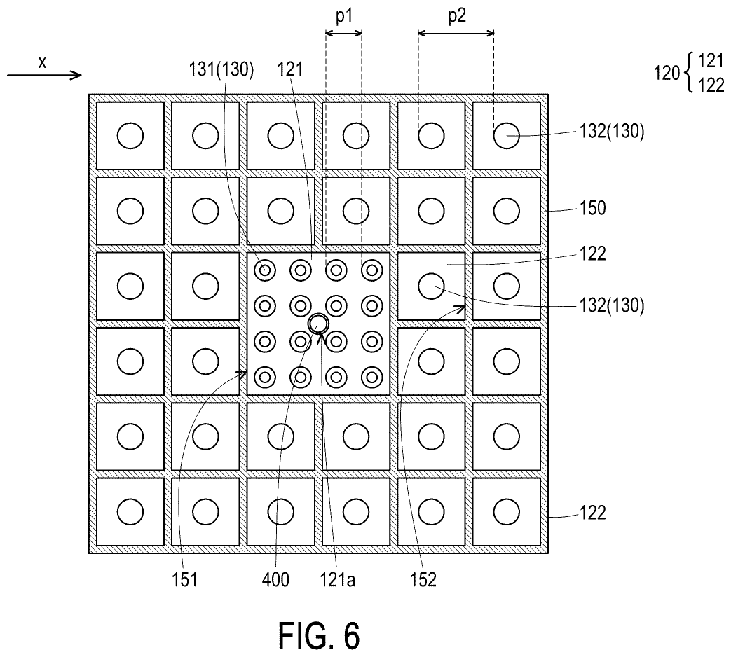

FIG. 5 is a cross-sectional view of an electronic system according to yet another embodiment of the present disclosure. FIG. 6 is a top view of a reflector, light emitting elements, and an image sensor according to yet another embodiment of the present disclosure. Referring to FIG. 5 and FIG. 6, the electronic system 1B of this embodiment is similar to the aforementioned electronic system 1, and the difference between both is that: the backlight module 100B of the electronic system 1B of this embodiment is different from the backlight module 100 of the aforementioned electronic system 1. Specifically, in this embodiment, the backlight module 100B further includes a reflective grating element 150 disposed on the reflector 120. The reflective grating element 150 has a first grating 151 and a plurality of second gratings 152. The plurality of first light-emitting elements 131 are disposed in the same first grating 151. The plurality of second light emitting elements 132 are respectively disposed in the plurality of second gratings 152. Through the arrangement of the reflective grating element 150, the light distribution of the backlight module 100B may be more concentrated, which helps to improve optical performance and visual quality.

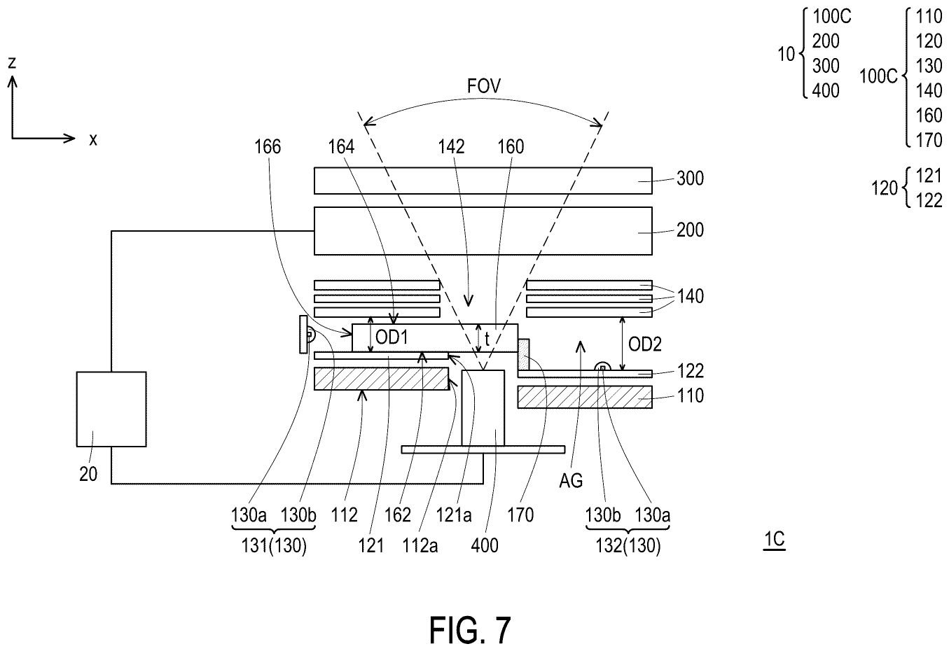

FIG. 7 is a cross-sectional view of an electronic system according to still another embodiment of the present disclosure. Referring to FIG. 7, the electronic system 1C of this embodiment is similar to the aforementioned electronic system 1, and the difference between both is that: the backlight module 100C of the electronic system 1C of this embodiment is different from the backlight module 100 of the aforementioned electronic system 1. Specifically, in this embodiment, the backlight module 100C further includes a light guide plate 160 and a light blocking element 170. The light guide plate 160 is disposed between the first portion 121 of the reflector 120 and the optical film 140. The light guide plate 160 has a bottom surface 162 facing the first portion 121 of the reflector 120, a light exit surface 164 opposite to the bottom surface 162, and a light entrance surface 166 connecting between the bottom surface 162 and the light exit surface 164, and the first light-emitting element 131 is disposed beside the light entrance surface 166 of the light guide plate 160. In this embodiment, the ratio of the thickness t of the light guide plate 160 in the first direction z to the first distance OD1 may fall in a range of 0.25 to 1. There is an air gap AG between the second portion 122 of the reflector 120 and the optical film 140. The light blocking element 170 separates the air gap AG from the light guide plate 160. A portion of the backlight module 100C corresponding to the first portion 121 of the reflector 120 is edge-lit type, and a portion of the backlight module 100C corresponding to the second portion 122 of the reflector 120 is direct-lit type.

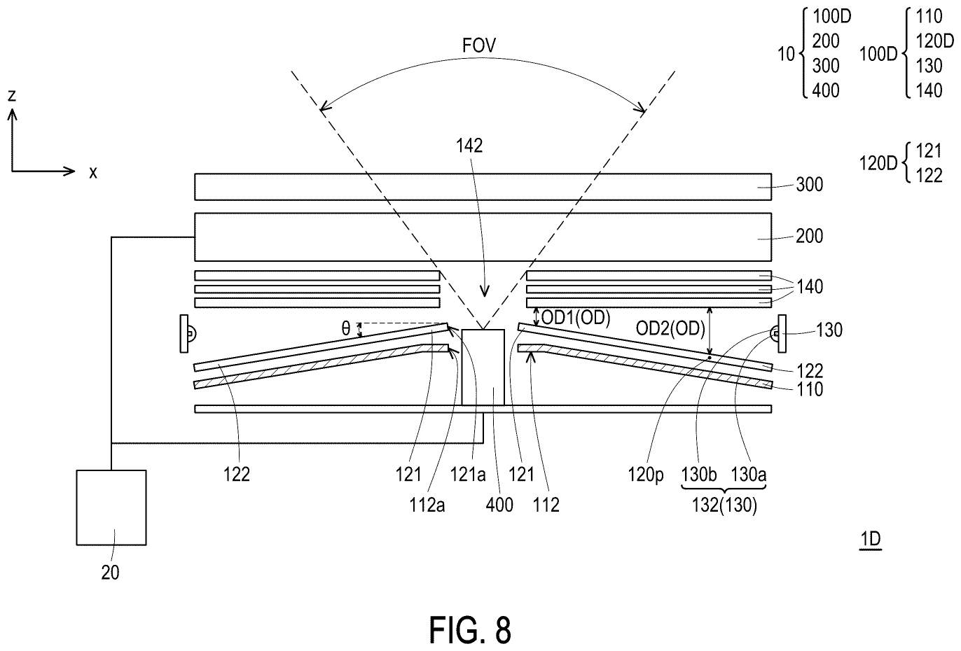

FIG. 8 is a cross-sectional view of an electronic system according to an embodiment of the present disclosure. Referring to FIG. 8, the electronic system 1D of this embodiment is similar to the aforementioned electronic system 1, and the difference between both is that: the backlight module 100D of the electronic system 1D of this embodiment is different from the backlight module 100 of the aforementioned electronic system 1. Specifically, in this embodiment, the distance OD in the first direction z between one point 120p on the reflector 120 and the optical film 140 gradually decreases as this point 120p approaches the opening 121a. In this embodiment, the reflector 120D and the optical film 140 may form an angle θ. The angle θ may fall in a range of 5° to 25°.

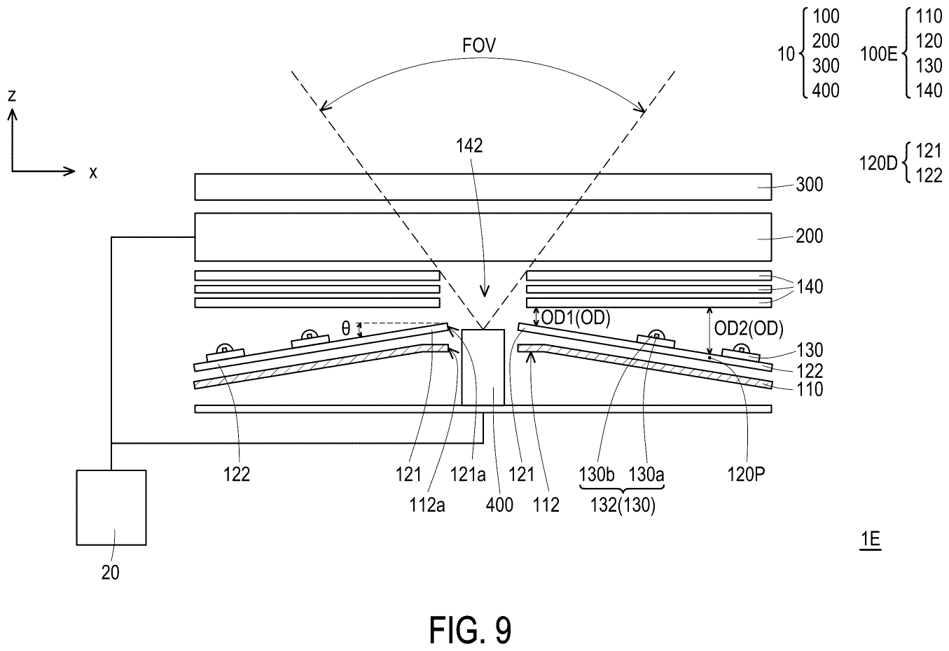

FIG. 9 is a cross-sectional view of an electronic system according to another embodiment of the present disclosure. Referring to FIG. 9, the electronic system 1E of this embodiment is similar to the electronic system 1D of FIG. 8, the reflector 120E and the optical film 140 of the electronic system 1E of FIG. 9 also form an angle θ, and the difference between both is that: in the embodiment of FIG. 8, the light input method of the backlight module 100D is edge-lit type; in the embodiment of FIG. 9, the light input method of the backlight module 100E is direct-lit type.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display apparatus, comprising:
a backlight module, comprising:
a reflector, comprising a first portion and a second portion outside the first portion, wherein the first portion of the reflector has an opening;
at least one light emitting element, located on the reflector; and
at least one optical film, located above the reflector, wherein a first direction is perpendicular to the at least one optical film, there is a first distance between the first portion of the reflector and the at least one optical film in the first direction, there is a second distance between the second portion of the reflector and the at least one optical film in the first direction, and the first distance is less than the second distance; and
a display panel, disposed on the backlight module.

2. The display apparatus as described in claim 1, further comprising:
an image sensor, disposed corresponding to the opening of the first portion of the reflector.

3. The display apparatus as described in claim 2, wherein the backlight module further comprises:
a back frame, having a recess recessing toward the display panel, wherein the first portion of the reflector overlaps the recess of the back frame, and at least one portion of the image sensor is disposed in the recess of the back frame.

4. The display apparatus as described in claim 1, wherein a ratio of an area of the first portion of the reflector to an area of the opening is greater than 120%.

5. The display apparatus as described in claim 1, wherein a ratio of the second distance to the first distance falls in a range of 1.5 to 5.

6. The display apparatus as described in claim 1, wherein the at least one light emitting element comprises:
a plurality of first light-emitting elements, disposed on the first portion of the reflector; and
a plurality of second light emitting elements, disposed on the second portion of the reflector;
wherein, a second direction is parallel to the at least one optical film, the first light-emitting elements are arranged with a first spacing in the second direction, the second light emitting elements are arranged with a second spacing in the second direction, and the first spacing is less than the second spacing.

7. The display apparatus as described in claim 1, wherein the at least one light emitting element comprises:
a plurality of first light-emitting elements, disposed on the first portion of the reflector; and
a plurality of second light emitting elements, disposed on the second portion of the reflector;
wherein, a second direction is parallel to the at least one optical film, the first light-emitting elements are arranged with a first spacing in the second direction, the second light emitting elements are arranged with a second spacing in the second direction, and a ratio of the second spacing to the first spacing falls in a range of 0.99 to 3.

8. The display apparatus as described in claim 1, wherein each of the at least one light emitting element comprises a light-emitting chip and a transparent package covering the light-emitting chip, the at least one light emitting element comprises:
a plurality of first light-emitting elements, disposed on the first portion of the reflector, wherein each of the first light-emitting elements further comprises a scatterer, disposed on the transparent package; and
a plurality of second light emitting elements, disposed on the second portion of the reflector, wherein the transparent package of each of the second light emitting elements directly contacts an air gap between the at least one optical film and the reflector.

9. The display apparatus as described in claim 8, wherein a ratio of an area of the scatterer of the first light-emitting element to an area of the transparent package of the first light-emitting element falls in a range of 20% to 60%.

10. The display apparatus as described in claim 1, wherein the at least one light emitting element comprises a plurality of first light-emitting elements disposed on the first portion of the reflector and a plurality of second light emitting elements disposed on the second portion of the reflector, the backlight module further comprises:
a reflective grating element, disposed on the reflector, and having a first grating and a plurality of second gratings, wherein the first light-emitting elements are disposed in the same first grating, and the second light emitting elements are respectively disposed in the second gratings.

11. The display apparatus as described in claim 1, wherein the at least one light emitting element comprises a first light-emitting element disposed on the first portion of the reflector and a second light emitting element disposed on the second portion of the reflector, the backlight module further comprises:
a light guide plate, disposed between the first portion of the reflector and the at least one optical film, wherein the light guide plate has a bottom surface facing the first portion of the reflector, a light exit surface opposite to the bottom surface, and a light entrance surface connecting between the bottom surface and the light exit surface, and the first light-emitting element is disposed beside the light entrance surface of the light guide plate; and
a light blocking element, separating an air gap between the second portion of the reflector and the at least one optical film from the light guide plate.

12. The display apparatus as described in claim 11, wherein a ratio of a thickness of the light guide plate in the first direction to the first distance falls in a range of 0.25 to 1.

13. The display apparatus as described in claim 1, wherein a distance between a point on the reflector and the at least one optical film in the first direction gradually decreases as the point approaches the opening.

14. An electronic system, comprising:
a backlight module, comprising:
a reflector, comprising a first portion and a second portion outside the first portion, wherein the first portion of the reflector has an opening;
at least one light emitting element, located on the reflector; and
at least one optical film, located above the reflector, wherein a first direction is perpendicular to the at least one optical film, there is a first distance between the first portion of the reflector and the at least one optical film in the first direction, there is a second distance between the second portion of the reflector and the at least one optical film in the first direction, and the first distance is less than the second distance;
a display panel, disposed on the backlight module;
a image sensor, disposed corresponding to the opening of the first portion of the reflector; and
a processing element, electrically connected to the image sensor.

15. The electronic system as described in claim 14, wherein the backlight module further comprises:
a back frame, having a recess recessing toward the display panel, wherein the first portion of the reflector overlaps the recess of the back frame, and at least a portion of the image sensor is disposed in the recess of the back frame.

16. The electronic system as described in claim 14, wherein a ratio of an area of the first portion of the reflector to an area of the opening is greater than 120%.

17. The electronic system as described in claim 14, wherein a ratio of the second distance to the first distance falls in a range of 1.5 to 5.

18. The electronic system as described in claim 14, wherein the at least one light emitting element comprises:
a plurality of first light-emitting elements, disposed on the first portion of the reflector; and
a plurality of second light emitting elements, disposed on the second portion of the reflector;
wherein, a second direction is parallel to the at least one optical film, the first light-emitting elements are arranged with a first spacing in the second direction, the second light emitting elements are arranged with a second spacing in the second direction, and the first spacing is less than the second spacing.

19. The electronic system as described in claim 14, wherein the at least one light emitting element comprises:
a plurality of first light-emitting elements, disposed on the first portion of the reflector; and
a plurality of second light emitting elements, disposed on the second portion of the reflector;
wherein, a second direction is parallel to the at least one optical film, the first light-emitting elements are arranged with a first spacing in the second direction, the second light emitting elements are arranged with a second spacing in the second direction, and a ratio of the second spacing to the first spacing falls in a range of 0.99 to 3.

20. The electronic system as described in claim 14, wherein each of the at least one light emitting element comprises a light-emitting chip and a transparent package covering the light-emitting chip, the at least one light emitting element comprising:
a plurality of first light-emitting elements, disposed on the first portion of the reflector, wherein each of the first light-emitting elements further comprises a scatterer, disposed on the transparent package; and
a plurality of second light emitting elements, disposed on the second portion of the reflector, wherein the transparent package of each of the second light emitting elements directly contacts an air gap between the at least one optical film and the reflector.
